(19) United States
(12) Patent Application Publication
(10) Pub. No.: US 2008/0127055 A1
(43) Pub. Date: May 29, 2008

(54) APPLICATION PROXY

(75) Inventors: Jackson M. Davis, Bothell, WA (US); Paul Stubbs, Redmond, WA (US); John A. Shepard, Seattle, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/470,959

(22) Filed: Sep. 7, 2006

(51) Int. Cl. G06F 9/45

(52) U.S. Cl. 717/106

(57) ABSTRACT

A facility is provided for enabling an application proxy that is capable of customizing an integrated development environment to execute in-process with the integrated development environment. In various embodiments, the facility loads a project file, determines whether the project file indicates an application proxy, and when the project file indicates an application proxy, loads the application proxy so that the application proxy can customize the integrated development environment based on configuration settings. In various embodiments, the facility includes a project file associated with an application, an application proxy component, and an integrated development environment that loads the application proxy component when loading the project file so that the application proxy component can handle communications between the integrated development environment and the application to customize the integrated development environment for use with the application.

### CROSS-REFERENCE TO RELATED APPLICATION(S)

This patent application is related to U.S. patent application Ser. No. ______ (Attorney Docket No. 418268360US), entitled “MANAGING APPLICATION CUSTOMIZATION,” U.S. patent application Ser. No. ______ (Attorney Docket No. 418268361 US), entitled “CONNECTING WITH AN APPLICATION INSTANCE,” and U.S. patent application Ser. No. ______ (Attorney Docket No. 418268357US), entitled “CONTROLLING APPLICATION FEATURES,” which applications are being filed concurrently and which are hereby incorporated by reference in their entireties.

### BACKGROUND

Software developers generally use integrated development environments (“IDEs”) to edit, build, and debug applications. An example of an IDE is MICROSOFT VISUAL STUDIO, which is a software development tool that is provided by MICROSOFT CORPORATION. IDEs provide a user interface that developers can use to develop software components and applications. IDEs generally include developer tools, such as a source code editor, a compiler and/or interpreter, a build-automation tool, and a debugger. IDEs may also include a version control system and other tools to simplify construction of a graphical user interface (“GUI”).

IDEs can have various containers for constituents of applications, such as image files, source code files, libraries, and so forth. As examples, IDEs can have solution and project containers. A solution container can contain, among other things, one or more project containers. The project containers can contain constituents of applications. The constituents of the applications can be “built” by the IDE's developer tools (e.g., compiler), such as by translating human-readable source code to machine-executable object code. Each project container can be said to be a different project type because it can provide support for a different programming language. Examples of programming languages are C#, C++, MICROSOFT VISUAL BASIC, PERL, and so forth. A project container (or simply, “a project”) is generally defined by a project file. The project file can indicate items associated with the project, such as various properties associated with the project, files that define the components the project contains, and so forth.

Developers employ IDEs to build software components, such as controls and add-ins. A control is generally a component that a developer adds to a form to enable or enhance a user's interaction with the form. As an example, a developer can add a Portable Document Format (“PDF”) reader control to a web form so that a viewer of the web form can view a PDF document. An add-in is a component that a user can add to an application (“host application”) to supplement the host application's functionality. As an example, a user can use an add-in with a MICROSOFT OFFICE host application (e.g., MICROSOFT WORD) to create a PDF document based on contents of the host application.

The IDE starts either when a user commands it to start or when an application starts it. As an example, when an add-in encounters an unexpected or specified condition, such as when an add-in encounters an error or a specified breakpoint, it can start the IDE. A breakpoint is a point in executable code at which a user has indicated to suspend execution. When the add-in encounters an error or breakpoint, the add-in can invoke the IDE and identify a region of source code within which the error or breakpoint can be found. If the IDE is not already executing when the add-in invokes it, the IDE will start. The IDE will then locate the relevant source code and display the identified region. Alternatively, an application can start the IDE, such as when the user selects a command for editing code associated with the application. Examples of code that can be associated with an application include source code, object code, scripts, macros, and so forth.

Conventionally, an application that is associated with the add-in controls the IDE. This can require inter-process communications between the IDE and the application, which each execute in different process spaces. Inter-process communications are known to cause various performance problems. Such problems can occur because an operating system on which the IDE and application execute may need to route the communications between the various processes. As an example, the operating system may need to communicate to the IDE the location of a particular add-in's breakpoints and may need to communicate to the application information that causes the IDE to invoke a set of steps, such as when a user indicates to continue executing from a breakpoint.

### SUMMARY

A facility is provided for enabling an application proxy, that is capable of customizing an integrated development environment, to execute in-process with the integrated development environment. The IDE loads the application proxy when the IDE loads a project that indicates that an application proxy should be loaded to communicate with an identified application. The application proxy can start or connect with the application and handles communications between the IDE and the identified application. The application proxy can batch or logically combine inter-process communications calls. A software developer that develops an application proxy can do so without having to provide logic to handle multiple project types. Once the application proxy is loaded, it can customize the IDE, such as to indicate which menu options to show or hide; toolbars to make available or disable; windows to make visible, available, or unavailable; commands to enable or disable; colors for various portions of the IDE, positions of windows, commands, and toolbars; and so forth. The application proxy can manipulate source or object code, such as by injecting source code when the user places a control on a form. An application proxy can also access a collection of properties that are associated with projects that identify the application proxy.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1A is a block diagram illustrating an example of a suitable computing environment in which the facility may operate in some embodiments.

FIG. 1B is a block diagram illustrating a storage unit of FIG. 1A in further detail in some embodiments.

FIG. 2A is a block diagram illustrating communications flows between various components associated with the facility in various embodiments.

FIG. 2B is a block diagram illustrating a component stack associated with the facility in some embodiments.

FIG. 3 is a flow diagram illustrating a load_project routine invoked by an integrated development environment in some embodiments.

FIG. 4 is a flow diagram illustrating a customize_IDE routine invoked by an application proxy component associated with the facility in some embodiments.

FIG. 5 is a flow diagram illustrating a record_macro routine invoked by an application in some embodiments of the facility.

FIG. 6 is a flow diagram illustrating a debug routine invoked by an application in some embodiments of the facility.

### DETAILED DESCRIPTION

A facility is provided for enabling an application proxy, that is capable of customizing an integrated development environment, to execute in-process with the integrated development environment. In various embodiments, the IDE loads the application proxy when the IDE loads a project that indicates that an application proxy should be loaded to communicate with an identified application. The application proxy can start or connect with the application and handles communications between the IDE and the identified application. The application proxy can batch or logically combine inter-process communications calls. As an example, when the application creates a toolbar button in the IDE, the application can make one inter-process communications call to the application proxy to command it to create the button. The application proxy then makes the toolbar visible if it is not, creates and positions a button, sets the button's various properties, and attaches it to the toolbar. Without the application proxy, the application would have to make several inter-process communications calls to command the IDE to take these steps, thereby decreasing performance of the IDE.

In some embodiments, a software developer that develops an application proxy can do so without having to provide logic to handle multiple project types. This is so because each project provides an indication to the IDE of the application proxies that correspond to the project. Because the IDE loads application proxies that are indicated to be associated with projects the IDE loads, the IDE will not load an application proxy that has not been identified in a project. Thus a developer of an application proxy may not need to provide logic for handling conditions associated with a project type with which the application proxy is not designed to function. As an example, a developer of an application proxy for MICROSOFT EXCEL may not need to provide logic for handling a MICROSOFT VISUAL C++ project type.

Once the application proxy is loaded, it can customize the IDE. As examples, it can indicate menu options to show or hide; toolbars to make available or disable; windows to make visible, available, or unavailable; commands to enable or disable; colors for various portions of the IDE, positions of windows, commands, and toolbars; and so forth.

In some embodiments, the application proxy can manipulate source or object code. As examples, the application proxy can add, remove, or modify source or object code. The application proxy can add source code when, for example, the user places an object (e.g., pushbutton or other user interface control) on a form. The user could then provide additional code to hook up the source code added by the application proxy to other logic associated with the object the user added.

An application proxy can retrieve properties from a “property bag” stored in the project(s) with which the application proxy is associated. A property bag is a collection of properties. The application proxy can also store properties in these property bags and modify these properties. An example of a property is a location indicator that identifies a location from which the IDE or application proxy can retrieve additional components associated with the project. As an example, the location indicator can identify a database location, uniform resource locator (“URL”), or other location from which the IDE or application proxy can retrieve additional components.

In some embodiments, the facility can employ an application proxy that can operate independently from its corresponding application. In these embodiments, the corresponding application may not be fully or even partially loaded. As an example, an application proxy can provide to an IDE forms, commands, and other aspects of the corresponding application. An application proxy may thus be employed in a server environment in which loading the corresponding application may be undesirable or impossible, or in other circumstances.

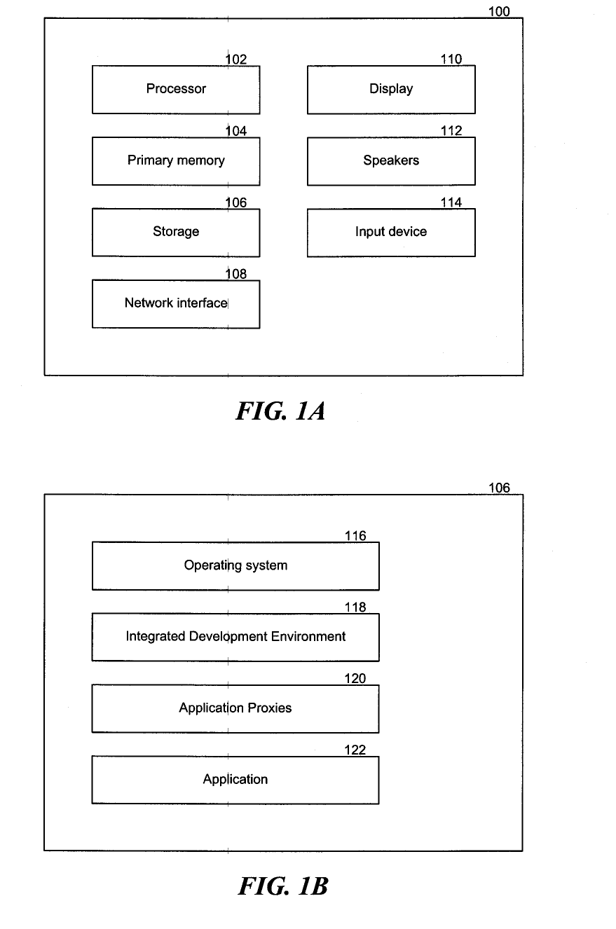

The facility is described in more detail in reference to the Figures. FIG. 1A is a block diagram illustrating an example of a suitable computing environment 100 in which the facility may be implemented. A system for implementing the facility includes a general purpose computing device in the form of the computing system (“computer”) 100. Components of the computer 100 may include, but are not limited to, a processing unit 102, a system primary memory 104, a storage unit 106, a network interface or adapter 108, a display 110, one or more speakers 112, and an input device 114.

The computer 100 typically includes a variety of computer-readable media that are operable with the storage unit 106. Computer-readable media can be any available media that can be accessed by the computer 100 and include both volatile and nonvolatile media and removable and nonremovable media.

The computer 100 may operate in a networked environment using logical connections to one or more remote computers. A remote computer may be a personal computer, a server, a router, a network PC, a peer device, or other common network node, and typically includes many or all of the elements described above in relation to the computer 100. A logical connection can be made via a local area network (LAN) or a wide area network (WAN), but may also be made via other networks. Such networking environments are commonplace in homes, offices, enterprisewide computer networks, intranets, and the Internet. The computer 100 can be connected to a network through the network interface 108, such as to a wired or wireless network.

The computer 100 is only one example of a suitable computing environment and is not intended to suggest any limitation as to the scope of use or functionality of the facility. Neither should the computing system environment be interpreted as having any dependency or requirement relating to any one or a combination of the illustrated components.

The facility is operational with numerous other general purpose or special purpose computing system environments or configurations. Examples of well-known computing systems, environments, and/or configurations that may be suitable for use with the facility include, but are not limited to, personal computers, server computers, handheld or laptop devices, cellular telephones, tablet devices, multiprocessor systems, microprocessor-based systems, set-top boxes, programmable consumer electronics, network PCs, minicomputers, mainframe computers, distributed computing environments that include any of the above systems or devices, and the like.

The facility may be described in the general context of computer-executable instructions, such as program modules, that are executed by a computer. Generally, program modules include routines, programs, objects, components, data structures, and so forth that perform particular tasks or implement particular abstract data types. The facility may also be employed in distributed computing environments where tasks are performed by remote processing devices that are linked through a communications network. In a distributed computing environment, program modules may be located in local and/or remote computer storage media, including memory storage devices.

FIG. 1B is a block diagram illustrating a storage unit of FIG. 1A in further detail in some embodiments. According to the illustrated embodiment, the storage unit 106 stores an operating system 116, an IDE 118, one or more application proxies 120, and an application 122. The IDE can be any IDE that a software developer can employ during development, such as MICROSOFT VISUAL STUDIO. In some embodiments, the IDE may provide a common framework that can be customized for various uses. As an example, a version of MICROSOFT VISUAL STUDIO can be employed with MICROSOFT OFFICE to create, modify, or debug macros. Macros are series of instructions that can command an application to complete a task. The application proxies can be associated with one or more IDE projects. A project can identify one or more application proxies that the IDE is to load when it loads the project. The application can be any application that is configured for use with an IDE, such as an application that functions with add-ins, macros, and so forth. Examples of such applications are MICROSOFT WORD, MICROSOFT EXCEL, MICROSOFT OUTLOOK, and others. Applications that are not developed by MICROSOFT CORPORATION can also function with IDEs. These applications may be associated with one or more application proxies and IDE projects.

While various functionalities and data are shown in FIGS. 1A and 1B as residing on particular computer systems that are arranged in a particular way, those skilled in the art will appreciate that such functionalities and data may be distributed in various other ways across computer systems in different arrangements. While computer systems configured as described above are typically used to support the operation of the facility, those skilled in the art will appreciate that the facility may be implemented using devices of various types and configurations, and having various components.

The techniques can be described in the general context of computer-executable instructions, such as program modules, executed by one or more computers or other devices. Generally, program modules include routines, programs, objects, components, data structures, etc., that perform particular tasks or implement particular abstract data types. Typically, the functionality of the program modules may be combined or distributed as desired in various embodiments.

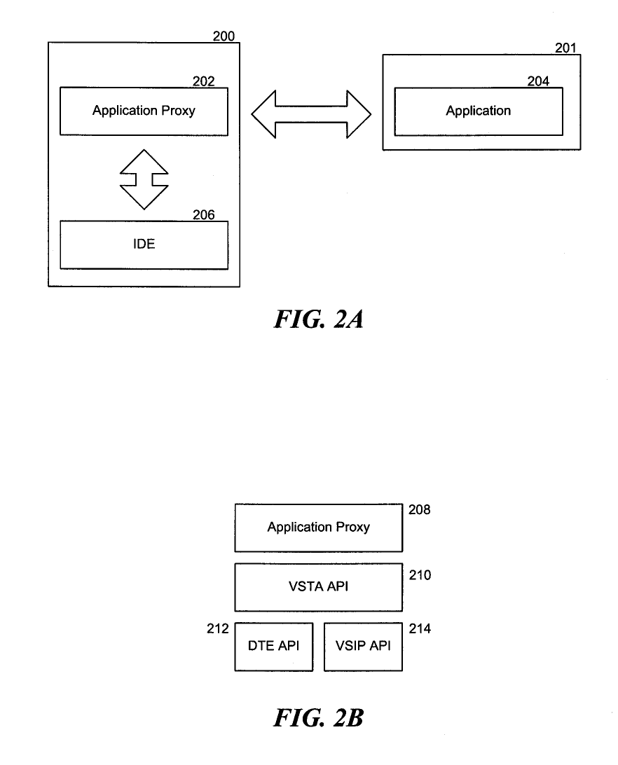

FIG. 2A is a block diagram illustrating communications flows between various components associated with the facility in various embodiments. A process space 200 includes an IDE 206 and one or more application proxies 202. The IDE loads the application proxies that correspond to the application(s) 204 with which the IDE communicates, such as an application that is identified in a project the IDE opens. The application generally executes in a process space 201 that is separate from the IDE's process space. When multiple applications execute, they each may operate in their own process space. Communications between process space 201 and process space 200 are referred to as inter-process communications. The processes can execute on the same or different computing devices, but may nevertheless be able to communicate using inter-process communications. Techniques for inter-process communications include message passing, synchronization, shared memory, remote procedure calls, and so forth. The facility can employ any technique employed in the art to enable processes to communicate with each other.

In some embodiments, the application may communicate with the application proxy, the IDE, or both. As an example, the application may communicate some commands to the application proxy and other commands directly to the IDE. When the application proxy is not compatible with the application, such as because they have different version numbers, the application may be able to communicate more effectively with the IDE than with the application proxy. Thus, while IDE performance may deteriorate, no functionality is lost.

Components within a process space can communicate with each other, such as by invoking each other's application program interfaces (“APIs”). As an example, the application proxy and IDE can communicate with each other. Another way a component can communicate with another component within a process space is to implement specific interfaces expected by the other component. Alternatively, the components may employ any other known mechanism for intra-process communications.

FIG. 2B is a block diagram illustrating a component stack associated with the facility in some embodiments. The component stack describes components that generally communicate with one another. As an example, components that are adjacent in the diagram may communicate with one another to complete various tasks. An application proxy 208 that is loaded by an IDE when the IDE loads a project can employ a Visual Studio Tools for Applications (“VSTA”) API 210. VSTA is an environment for application customization that is built on the MICROSOFT .NET (“dot-NET”) framework. Application developers can employ various programming languages to customize applications that support VSTA. As an example, a developer can employ either MICROSOFT VISUAL BASIC or MICROSOFT VISUAL C# to customize versions of MICROSOFT EXCEL that support VSTA. A VSTA component provides an API that the application proxy can use to command an IDE that supports VSTA, such as MICROSOFT VISUAL STUDIO. The application proxy can invoke methods provided by the VSTA API to control the IDE, such as when the application proxy receives inter-process communications from the application. The application proxy can be implemented as an add-in to the IDE. Add-ins provide the ability to interact with most of the features and tools found in the IDE, including code editors, a code model, output and debugging windows, editors, menus, and other commonly used interfaces.

The VSTA API can employ an automation interface provided by the IDE, such as DTE API 212. DTE is the top-level automation object provided by MICROSOFT VISUAL STUDIO. Components can employ the DTE to command the IDE to take various actions, such as to open and close windows, invoke IDE commands, inject code, and so forth. VSTA is described in detail at MICROSOFT CORPORATION's web site.

The VSTA API can also employ a customization API provided by the IDE, such as the Visual Studio Industry Partners (“VSIP”) API 214 provided by MICROSOFT VISUAL STUDIO. The VSIP API provides methods to customize the IDE, such as to add or remove commands, windows, user interface elements, and so forth. VSIP is described in detail at MICROSOFT CORPORATION's web site.

Thus, the application proxy is able to customize and command the IDE on behalf of the application.

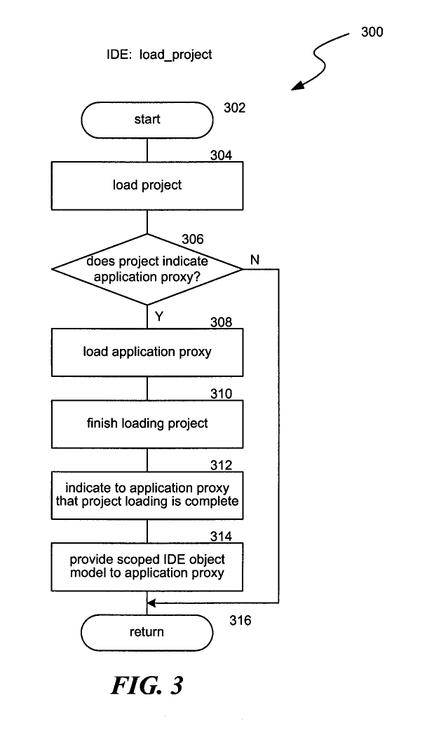

FIG. 3 is a flow diagram illustrating a load_project routine invoked by an integrated development environment in some embodiments. The routine 300 can be invoked by the IDE when it loads a project, such as when a user requests the IDE to open the project. The routine begins at block 302.

At block 304, the routine loads the indicated project.

At decision block 306, the routine determines whether the project indicates an application proxy. The project can indicate an application proxy, e.g., by including a declaration for the application proxy. In various embodiments, the application proxy can be indicated using an identifier. The following Extensible Markup Language (“XML”) declaration of a portion of a project file provides an example that identifies an application proxy:

```
<ProjectClient>
    <HostIdentifier>WordProcessor</HostIdentifier>
    <InProcHost>{8C1425C9-A7D3-35CD-8248-
928CA52AD49B}</InProcHost>
    <HostProperties>
        <Property Name=“Option1” Value=“True”/>
        <Property Name=“Option2” Value=“Red”/>
        <Property Name=“IDECustomization” Value=“Yes”/>
        <Property Name=“File+Open” Value=“Off”/>
        ...
    </HostProperties>
</ProjectClient>
```

In this example, the application proxy's identifier is identified in an “InProcHost” element. In some embodiments, a value of this element may be a globally unique identifier that uniquely identifies the application proxy. The IDE, upon receiving this identifier, can determine a location at which the application proxy can be found, such as by looking up the value in a registry, database, or other location. Because the IDE is not provided with an executable file for the application proxy directly, it is less likely that the IDE will load malicious code because the IDE loads code that was previously installed, such as by an administrator. When the location is determined by a lookup (e.g., from a registry, database, or other location), an administrator can control not only the registry or database entry but also the location from which the application proxy is loaded. Thus, insertion of malicious code can be prevented.

In some embodiments, the project file is capable of providing executable code to the IDE, but then the IDE may load malicious code inadvertently. As an example, a user may maliciously or inadvertently insert code into a project file that the IDE will then load.

When an application proxy is installed, such as by an administrator or other user with sufficient rights, the location of the application proxy is stored, such as in a registry or database. In various embodiments, the location may be stored in several locations, so that, for example, multiple types of IDEs can access the installed application proxies. As an example, different IDEs may use different portions of a registry. In such a case the locations may be stored in several different portions of the registry.

If the project indicates an application proxy, the routine continues at block 308. Otherwise, the routine continues at block 316, where it returns.

At block 308, the routine loads the indicated application proxy. The IDE can load the indicated application proxy from the local disk or any network resource, such as a database, file server, and so forth.

At block 310, the routine completes loading the project once it has completed loading the application proxy. In various embodiments, the IDE may complete loading the project even when the application proxy has not yet been completely loaded.

At block 312, the routine sends an indication to the application proxy that project loading has completed. As an example, the routine may invoke a method provided by an API associated with the application proxy.

At block 314, the routine provides a “scoped” IDE object model to the application proxy. Scoping is a term used in the art to indicate an expansion or contraction of features that are appropriate for a given context. In various embodiments, the object model is scoped such that only commands, user interface elements, and other aspects of the IDE that are associated with the application, as indicated by the project or other configuration settings, are provided to the application proxy. By scoping the object model, components employing the object model may have access only to portions of the full object model associated with the IDE. Thus, for example, the IDE may only provide features appropriate to the loaded project.

At block 316, the routine returns.

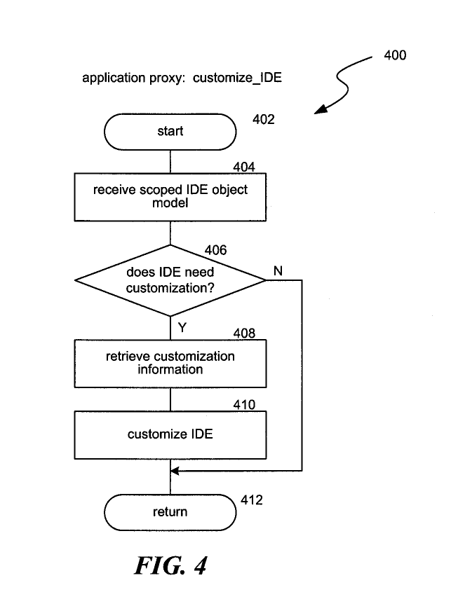

FIG. 4 is a flow diagram illustrating a customize_IDE routine invoked by an application proxy component associated with the facility in some embodiments. An application proxy can invoke the routine 400 to customize the IDE, e.g., if the project or configuration settings indicate that the IDE needs customization. Examples of customization include addition or removal of commands, user interface elements, and so forth. In various embodiments, the customization may be in addition to, or instead of, the customization provided by object model scoping. The routine begins at block 402.

At block 404, the routine receives a scoped IDE object model. Scoping of the IDE object model was described above in relation to FIG. 3.

At decision block 406, the routine determines whether the IDE needs customization. As an example, the routine may determine whether the IDE needs customization based on configuration settings that are specified in the project. The routine can retrieve settings from a property bag associated with the project. The property bag can contain configuration settings or any other properties. When the IDE loads the project and instantiates an application proxy, the IDE can provide an indication of the property bag to the application proxy. If the IDE needs customization, the routine continues at block 408. Otherwise, the routine continues at block 412, where it returns.

At block 408, the routine retrieves customization information from a location identified in the project, such as in the property bag. The customization information can be stored within the property bag, elsewhere in the project file, on a database, on a file server, or elsewhere.

At block 410, the routine customizes the IDE. The routine can customize the IDE by invoking various methods provided by a VSTA API or other API associated with the IDE or facility.

At block 412, the routine returns.

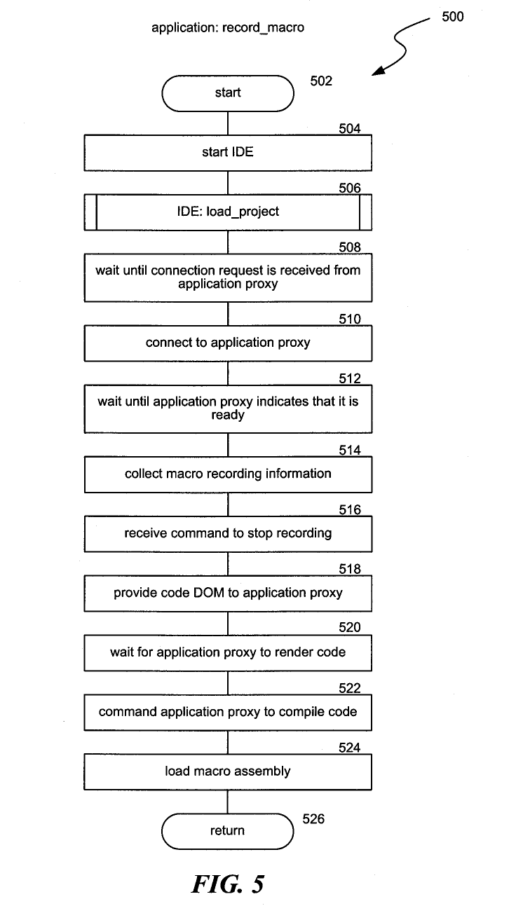

FIG. 5 is a flow diagram illustrating a record_macro routine invoked by an application in some embodiments of the facility. An application can invoke the record_macro routine 500, e.g., when a user commands the application to record a macro. The routine begins at block 502.

At block 504, the routine starts the IDE. As an example, the routine may invoke a dynamic load library (“DLL”) or executable file associated with the IDE.

At block 506, the routine invokes a load_project subroutine provided by the IDE. The load_project subroutine was described above in relation to FIG. 3. In various embodiments, the application may provide an indication of a project associated with the application when invoking the subroutine so that the IDE can load the indicated project. When the IDE loads the project, it may load an application proxy indicated by the project, as is described above in relation to FIG. 3. When the application proxy loads, it can send a connection request to the application.

At block 508, the routine waits until it receives a connection request from the application proxy or proxies indicated in the project. The application proxy can be indicated in the project file that the application identified when invoking the load_project subroutine at block 506. In various embodiments, instead of waiting for the connection request, the facility may provide an entry point that the application proxy invokes when the IDE has completed loading the project.

At block 510, the routine connects to the application proxy that sends a connection request. In so doing, the processes of the application and the IDE have established an inter-process communications channel so that the application can provide further commands to the IDE, such as via the application proxy.

At block 512, the routine waits until the application proxy indicates that it is ready. As an example, the application proxy can send an event or invoke a method provided by the application to indicate that the application proxy is ready to receive commands from the application.

At block 514, the routine collects macro recording information. In various embodiments, the application may record the information and provide the information later to the routine. The recording information is collected as the user performs various tasks in the application. As an example, the information can include keystrokes, menu commands invoked by the user, and so forth.

At block 516, the routine receives a command to stop recording. As an example, the user may indicate to the application to finish recording a macro.

At block 518, the routine provides a code document object model (“DOM”) to the application proxy. A code DOM is a structured representation of code, such as macro code that the facility collected. The code DOM that the routine provides includes the macro recording information that was collected at block 514 or provided to the routine by the application. The code DOM is a collection of commands or instructions associated with the steps the user took while recording the macro.

At block 520, the routine waits for the application proxy to render code. The application proxy may render code by invoking various methods associated with the VSTA API or other components of the facility. The code is rendered based on the macro recording information indicated by the code DOM. The application proxy can be designed specifically for use with the application, so that it has sufficient information to render code associated with commands or instructions indicated by the code DOM.

At block 522, the routine commands the application proxy to compile the code it rendered at block 520. The application proxy may, in turn, command the IDE to compile the rendered code. When code is compiled, the IDE emits an assembly. An assembly is a sequence of instructions that components associated with the operating system can invoke. As an example, the .NET framework provides a component that can load and invoke steps indicated by an assembly. In some embodiments, other components associated with the facility are also assemblies including, e.g., application proxies.

At block 524, the routine loads the macro assembly created by the IDE when commanded by the logic of block 522. The user can then invoke the assembly, such as by commanding the IDE or the application. When the user invokes the macro, the macro may invoke an object model associated with the application, such as by using the application's automation object API.

At block 526, the routine returns.

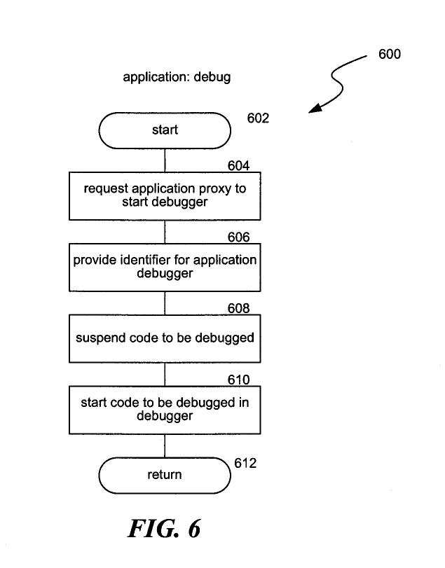

FIG. 6 is a flow diagram illustrating a debug routine invoked by an application in some embodiments of the facility. An application can invoke the debug routine 600 when a user commands the application to begin debugging a component, such as an add-in. Alternatively, the application may invoke the method when an add-in to the application detects an error condition or a breakpoint. The routine begins at block 602.

At block 604, the routine requests the application proxy to start the debugger. The application proxy can command the IDE to start the debugger, such as by invoking a method associated with the VSTA API or another API associated with the facility.

At block 606, the routine provides an identifier for the application to the debugger. As an example, the routine can provide the application's process identifier. The debugger can use this identifier to properly associate the debugged code with the application.

At block 608, the routine suspends the code that is to be debugged. As an example, the routine suspends the add-in. In various embodiments, the routine can terminate the debugged code so that it can be restarted in the debugger.

At block 610, the routine starts the code in the debugger. The debugger can then associate the code with the application based on the identifier that was provided above by the logic associated with block 606.

At block 612, the routine returns.

Those skilled in the art will appreciate that the logic illustrated in FIGS. 3-6 and described above may be altered in a variety of ways. For example, the order may be rearranged, substeps may be performed in parallel, shown logic may be omitted, or other logic may be included, etc.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

We claim:

1. A method performed by a computing system for customizing an integrated development environment, comprising:
loading a project file, the project file associated with an application, the application configured for use with the integrated development environment;
determining whether the project file indicates an application proxy, the application proxy for handling communications between the application and the integrated development environment; and
when the project file indicates an application proxy, loading the application proxy so that the application proxy can customize the integrated development environment based on configuration settings.

2. The method of claim 1 further comprising receiving multiple commands from the application proxy to customize the integrated development environment, the multiple commands corresponding to a single command received by the application proxy from the application.

3. The method of claim 1 further comprising suspending the loading of the project file while loading the application proxy.

4. The method of claim 1 further comprising indicating to the loaded application proxy that the project has completed loading.

5. The method of claim 1 further comprising scoping an object model associated with the integrated development environment so that at least one command associated with the integrated development environment is unavailable through the scoped object model.

6. The method of claim 5 further comprising providing the scoped object model to the application proxy.

7. The method of claim 6 further comprising receiving commands from the application proxy via the scoped object model.

8. A system for customizing an integrated development environment, comprising:
a project file associated with an application, the project file providing an identifier;
an application proxy component corresponding to the identifier provided in the project file and corresponding to the application; and
an integrated development environment that loads the application proxy component when loading the project file so that the application proxy component can handle communications between the integrated development environment and the application to customize the integrated development environment for use with the application.

9. The system of claim 8 wherein a solution file contains the project file.

10. The system of claim 8 wherein the application proxy component communicates with a Visual Studio Tools for Applications application program interface component associated with the integrated development environment.

11. The system of claim 10 wherein the application proxy component, upon receiving a command from the application, invokes multiple methods provided by the Visual Studio Tools for Applications application program interface component.

12. The system of claim 8 wherein the integrated development environment is MICROSOFT VISUAL STUDIO.

13. The system of claim 8 wherein the identifier is a globally unique identifier.

14. The system of claim 8 wherein the integrated development environment identifies a location for the application proxy based on the identifier provided by the project file and loads the application proxy from the identified location.

15. The system of claim 14 wherein the integrated development environment identifies the location by searching for the identifier in a registry.

16. The system of claim 15 wherein a portion of the registry in which the identifier is stored is not writable by a user account associated with a process space in which the integrated development environment executes.

17. A computer-readable medium having computer-executable instructions that, when executed, perform a method for customizing an integrated development environment, the method comprising:
determining whether a setting is available for customizing the integrated development environment for use with an application and customizing the integrated development environment accordingly;
receiving a command from the application to further customize the integrated development environment; and
invoking several methods provided by an application programming interface associated with the integrated development environment to further customize the integrated development environment.

18. The computer-readable medium of claim 17 wherein the application programming interface associated with the integrated development environment is provided by a Visual Studio Tools for Applications application programming interface component.

19. The computer-readable medium of claim 17 further comprising emitting code corresponding to a macro upon receiving from the application a command to render code.

20. The computer-readable medium of claim 17 further comprising, upon receiving a command to debug code associated with an add-in that is attached to the application, suspending the code and restarting the code in a debugger.
